(19) United States
(12) Patent Application Publication
(10) Pub. No.: US 2013/0258841 A1
(43) Pub. Date: Oct. 3, 2013

(54) Method for Protecting Data Transmission in MPLS Networks Due to Failures

(71) Applicants: Kieran Parsons, Cambridge, MA (US); Ke Wen, Davis, CA (US)

(72) Inventors: Kieran Parsons, Cambridge, MA (US); Ke Wen, Davis, CA (US)

(21) Appl. No.: 13/435,335

(22) Filed: Mar. 30, 2012

(51) Int. Cl. H04L 12/24

(52) U.S. Cl. 370/228

(57) ABSTRACT

A method protects data transmission from failures, wherein the data transmissions are from a source to a destination in a Multi-Protocol Label Switching (MPLS) network, and the data transmissions are via a labeled-switch path (LSP) with segment protection in protection domains. A maximum recovery time for each protection domain is constrained, and for each protection domain, one or more backup tunnels are determined. A graph of nodes of the LSP and the backup tunnels is constructed, wherein edges in the graph represent the links between the nodes. A weight is assigned to each edge to produce a weighted graph. Based on the weighted graph, a path from the source to the destination that satisfies a reliability constraint with a minimum cost is determined by using an optimal combination of segment protections and a reliability-guaranteed least-cost

### FIELD OF THE INVENTION

This invention relates generally to Multi-Protocol Label Switching (MPLS) in Wavelength Division Multiplexing (WDM) networks, and more particularly to the survivable and cost-efficient path computation and protection of Label-Switched Paths (LSPs) in MPLS networks.

### BACKGROUND OF THE INVENTION

Multi-Protocol Label Switching (MPLS) is a highly scalable, protocol insensitive, data transmission mechanism in conventional backbone networks. MPLS directs and transmits data from one network node to another using Label-Switched Paths (LSPs).

FIG. 1A shows a conventional protocol stack with IP 101, MPLS 102, Optical Transport Network (OTN) 103, and physical layers. MPLS directs data transmission from one node to the next based on short path labels rather than long network addresses, avoiding complex lookups in a routing table. The labels identify virtual links (paths) between distant nodes rather than endpoints.

It should be noted that networks according to other standards are also possible, e.g., Synchronous Optical Networking (SONET) and Synchronous Digital Hierarchy (SDH).

These MPLS packets are switched after a label lookup/switch instead of a lookup into the IP table. Label based routers are called label switch routers (LSRs). Labels are distributed using the Label Distribution Protocol (LDP).

With the emergence of diverse network applications, MPLS networks are required to provide differentiated service reliabilities for different users of the network. MPLS networks are most widely used in optical networks, where physical network resources (such as long-distance optical fibers) are vulnerable to numerous risks (failures) that may harm network connectivity.

These risks can come in land environments (e.g., natural disasters, such as earthquakes, floods and hurricanes), or human activities (e.g., underground construction, tunnel fires, drag nets and anchors). Marine environments pose a particular problem because failure locations are hard to detect and repair. It is therefore important to provide methods to satisfy network differentiated reliability requirements in a most cost-efficient way.

It is known that conventional routing methods, which usually only determine a shortest route, are prone to result in an LSP with a high failure probability, because the LSP may go through high-risk environments when failure-related factors are not considered.

Path computation methods, which determine the LSP with a minimum failure probability, also exist. However, those methods suffer from “detouring” routes in many cases, which result in costly consumption of network resources, as well as end-to-end delays.

Because the network requirements on LSP reliability for different users are differentiated and often not as stringent as the most reliable requirement, it is possible to save network costs while satisfying these requirements with just-enough reliability. The same principle also applies to LSP protection. With the risk information and correlated failure model for the network, LSP protection significantly improving on full path protection or local protection can be determined.

Therefore, a method for providing an optimal combination of segment protections (OCSP), which achieves a minimum joint failure probability, or a minimum cost with reliability guarantees, is needed.

### SUMMARY OF THE INVENTION

Embodiments of the invention provide a method to determine an optimum. Label Switched Path (LSP), which satisfies multiple requirements in a Multi-Protocol Label Switching (MPLS) optical network. The object is to protect data transmission the MPLS due to failures.

In one embodiment, termed Reliability-Guaranteed Least-Cost (RGLC) path computation, an LSP is determined, which satisfies the network reliability requirements with a minimum cost for differentiated users.

In another embodiment, termed Optimal Combination of Segment Protections with Minimum Failure Probability (OCSP-MFP), an optimal LSP protection is determined that provides a minimum joint failure probability.

In another embodiment, termed Optimal Combination of Segment Protections with Reliability-Guaranteed and Least-Cost (OCSP-RGLC), an optimal LSP protection is determined that satisfies network reliability requirement with a minimum cost.

### BRIEF DESCRIPTION OF THE DRAWINGS

FIG. 1A is a block diagram of a conventional protocol stack for an Optical Transport Network;

FIG. 1B is a schematic of an MPLS network in which embodiments of the invention operate;

FIG. 2 is a graph after all possible segment backup tunnels are added along a primary LSP;

FIG. 3 is a graph after link weight assignment based on FIG. 2;

FIG. 4 is a flow diagram of a general method for determining an optimal combination of segment protection that provides a minimum joint failure probability or satisfies network reliability requirement with a minimum cost;

FIG. 5A is a block diagram for performing a RGLC process on the graph from the origin to the destination to determine a reliability-guaranteed least-cost protection; and

FIG. 5B is a block diagram for performing a probability-wise shortest path procedure on the graph from the origin to the destination to determine a most reliable protection.

### DETAILED DESCRIPTION OF THE PREFERRED EMBODIMENT

Embodiments of our invention provide a method for protecting data transmission in a Multi-Protocol Label Switching (MPLS) network due to failures. In the MPLS network, reliability requirements of different users can be differentiated.

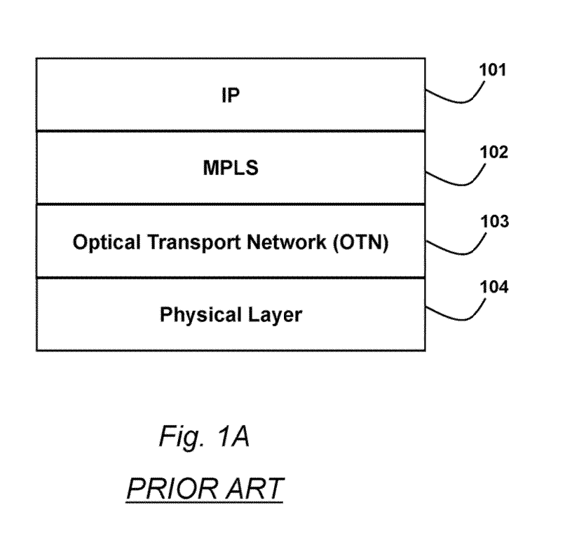

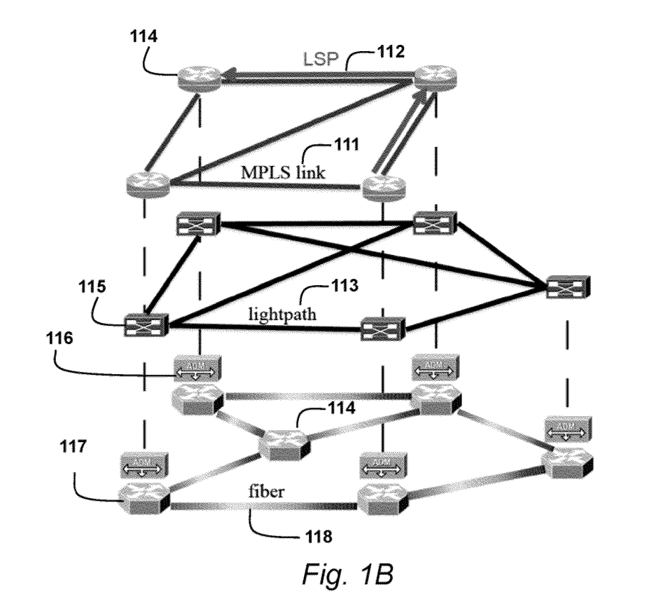

FIG. 1B shows The MPLS network with several layers. The layers include MPLS routers 114, Optical Transport Network (OTN) switches 115, add/drop multiplexers 116; and wavelength routed switches 117.

Path computation for a connection request in the MPLS network is used to determine a Label Switched Path (LSP) 112 at the MPLS layer between an origin node and a destination node.

In the MPLS-over-OTN-over-WDM multilayer network, an MPLS link 111 can be accommodated by one or a concatenation of lightpaths 113, which are constructed on an optical wavelength-division multiplexing (WDM) network.

Because the lightpaths may go through one or multiple fibers 114 in an underlying physical topology, any failure of the fibers (such as fiber cuts) may cause failure of data transmission on the MPLS links, degrading the reliability of the LSP.

As defined herein, a “lightpath” is an end-to-end connection between a source and a destination that travels on one or multiple fiber links. There can be multiple lightpaths on a single fiber. The lightpath can also traverse multiple fibers by passing through optical cross connects (e.g., wavelength routed switches.)

A probabilistic failure model used is described as follows. The physical fiber network is denoted by G=(V, E), where V represents nodes, and E represents edges (links) between the nodes.

Any link in EE is denoted by (s, t) for s, t ∈ V. There is a set R of risk events that can cause one or more fibers to fail. Each risk event T ⊂ R occurs with a probability πᵣ and is associated with a group of affected fibers, called a probabilistic shared risk link group (PSRLG). After the risk event r occurs, the physical link (s,t) in the SRLG^{r} may fail (f) with a conditional failure probability fₛₜ^{r} ∈[0,1].

Assume an MPLS link (i,j) at an upper layer physically goes through a set S_{f} of fibers, then a failure probability of MPLS link (i, j) under risk^{r} is

$${p}_{ij}^{r} = 1 - {\prod }_{( s , t ) ∈ {S}_{f}} ( 1 - {f}_{st}^{r} ) .$$

Because the risk events are generally independent, the risk-weighted failure probability of an LSP P is

$$F ( P ) = {\sum }_{r ∈ R} {π}_{r} [ 1 - {\prod }_{( i , j ) ∈ P} ( 1 - {p}_{ij}^{r} ) ] .$$

This path failure probability is averaged over all risk events because the failures are assumed to be mutually exclusive. Reasonable approximation can be considered under a low failure probability assumption (i.e., p^{r}ᵢⱼ<<1, ∀r, ∀(i, j)).

Because the second or higher order terms are much smaller, we have

$${\prod }_{( i , j ) ∈ P} ( 1 - {p}_{ij}^{r} ) \approx 1 - {\sum }_{( i , j ) ∈ P} {p}_{ij}^{r} .$$

Hence,

$$F ( P ) = {\sum }_{r ∈ R} {π}_{r} {\sum }_{( i , j ) ∈ P} {p}_{ij}^{r} = {\sum }_{( i , j ) ∈ P} ( {\sum }_{r ∈ R} {π}_{r} {p}_{ij}^{r} ) = {\sum }_{( i , j ) ∈ P} {p}_{ij} ,$$

where the term

$${p}_{ij} = ( {\sum }_{r ∈ R} {π}_{r} {p}_{ij}^{r} )$$

is the risk-weighted failure probability assigned to MPLS link (i,j).

Another weight is also assigned to each MPLS link. The other weight represents the “cost,” denoted by c(i, j), on this MPLS link if the selected LSP goes through the link. Here, the “cost” can be flexibly defined for the network. The cost can be any desired metric that is additive along the path, e.g., resource consumption, physical length, latency, etc.

The model of a Reliability-Guaranteed Least-Cost (RGLC) path computation method is

$$min {\sum }_{( i , j ) ∈ P} {c}_{ij} , subject to F ( P ) \leq {p}_{req} ,$$

where p_{req} is the required maximum failure probability of the LSP.

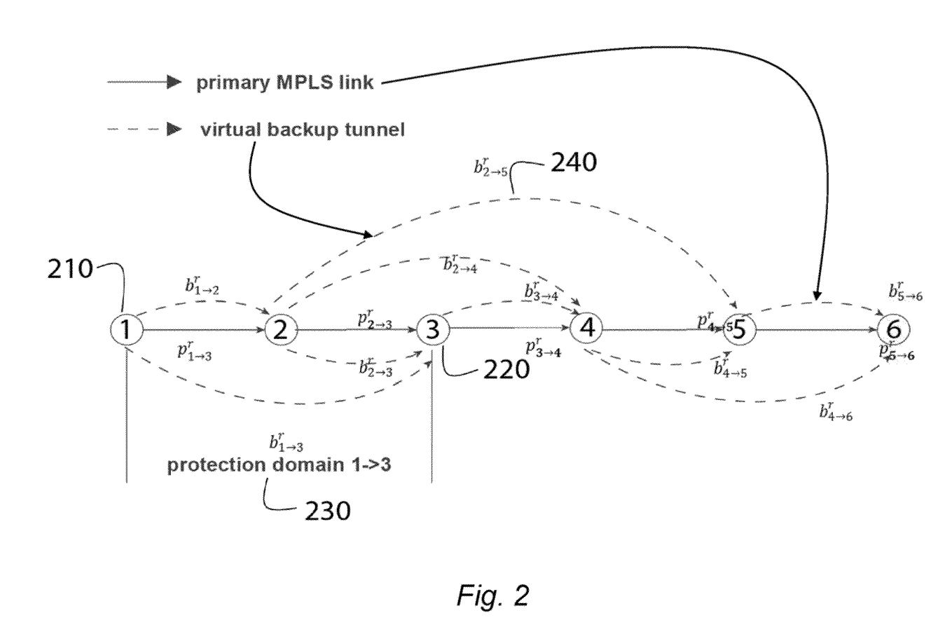

As shown in FIG. 2 for nodes 1-6, there is the origin 210 and the destination 260, labeled as node 1 and node n, respectively. We denote by gⱼ(c) the weighted failure probability of the most reliable path from the origin to intermediate node i, with the cost is at most c. Then, a dynamic programming procedure for RGLC path computation is

g₁(c)=0, c=0, . . . , OPT,

gⱼ(o)=∞, j=2, . . , n,

gⱼ(c)=min{gⱼ(c−1), min{gₖ(c−cₖⱼ)+pₖⱼ|^{k:c}ₖⱼ^{≦c}}}, ,

for j=2, . . . , c=1, . . . , OPT, ,

where OPT is the minimum cost among all of the 1→n paths satisfying the reliability constraint, i.e., OPT=Min {c|gₙ(c)≦p_{req}}.

The OPT is not known a priori, thus gⱼ(c is determined first for c=1 and j=2, . . . n, then for c=2 and j=2, . . . , n and so on, until the cost c satisfies gₙ(c)≦p_{req}. Then, OPT is set to this cost.

In the case of LSP protection, we describe a general method to select the optimal combination of protection domains and corresponding backup tunnels, under the reliability and/or recovery time constraint, with the goal of minimum joint failure probability or minimum protection cost. Other constraints can include the hop count or the distance along the path.

The protection domain includes the set of LSRs over which the LSP and its corresponding protection path are routed. Thus, a protection domain is bounded by the LSRs that provide the switching and merging functions for MPLS protection. These nodes are the PSL (Protection Switch Label switched Router, also called Protection Switch LSR) and the PML (Protection Merge Label switched Router, also called Protection Merge LSR), respectively, both of which are identified during the setting up of an LSP and its corresponding working and protection paths. Protection should ideally be performed between source and destination (end-to-end), but in some cases segment protection is desired.

As shown in FIG. 2, a protection domain (230) is a segment of the primary LSP between a PSL and a PML.

The PSL (210) is the LSR that is the origin of both the primary segment and its corresponding backup tunnel. When a failure is detected in its protection domain, via a Failure Indication Signal (FIS) or via its own detection mechanism, the PSL switches the data transmission to be protected from the PSL to the corresponding backup tunnel.

A PML (220) is an LSR that terminates both a primary segment and its corresponding backup tunnel, and either merges the data transmission into a single outgoing LSP, or, if the PML is the destination, passes the data transmission on to higher layer protocols. The protection method according to embodiment of the invention is described below.

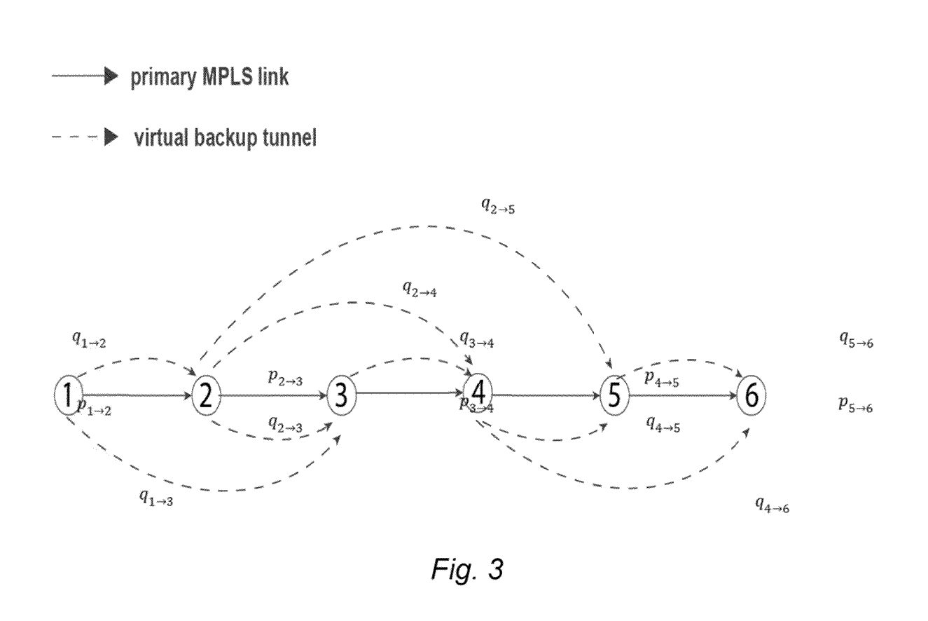

FIG. 3 shows the network of FIG. 2 with link weight q assignment as described herein.

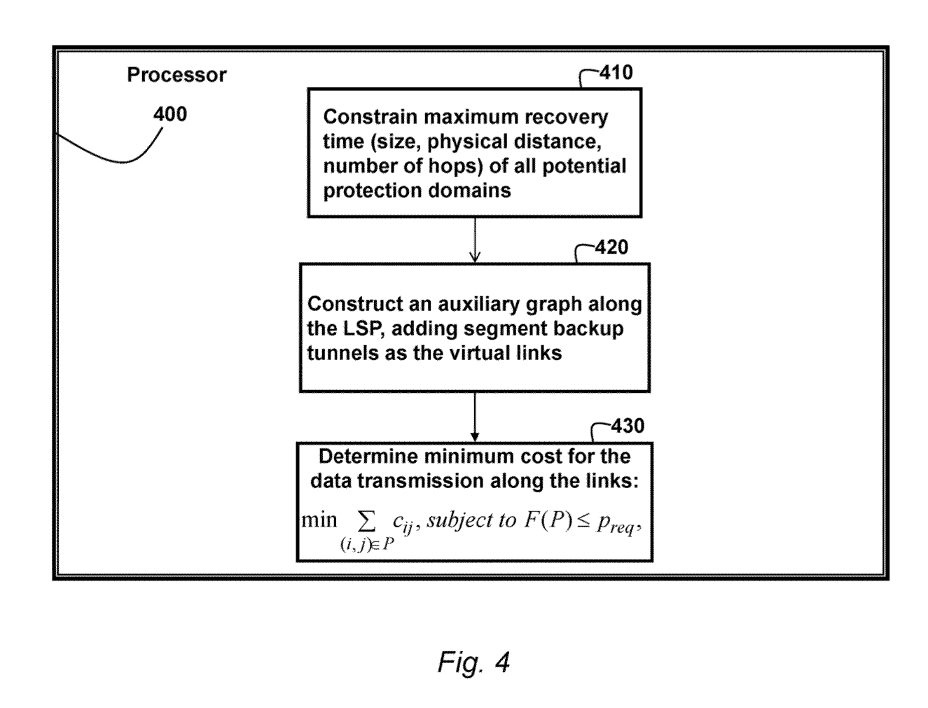

FIG. 4 shows a general method for determining an optimal combination of segment protection that provides a minimum joint failure probability or satisfies network reliability requirement with minimum cost, according to embodiments of our invention.

The steps of the method can be performed in a processor 400 connected to memory and input/output interfaces as known in the art. The method can also be performed in processors distributed over the network to increase reliability.

First, if the maximum recovery time constraint exists, because the recovery time is mainly made up of the transmission time for the FIS. The maximum recovery time constraint is 410 translated into a restriction on a maximum size of the potential protection domains (either measured by the physical length when mapped to the physical layer, or the number of links in that protection domain).

All protection domains that satisfy the maximum recovery time constraint becomes qualified protection domains.

Second, a graph is constructed 420 based on the primary LSP to assist in selecting the optimal combination of segment protections from the qualified protection domains.

Along the primary LSP, each backup tunnel for each qualified protection domain is inserted into the graph as a virtual link (dashed arrows in FIGS. 2-3, e.g., 240 as backup tunnel for protection domain 2→5).

A general method for determining the optimal combination of segment protections where the backup tunnels are routed is not restricted. The backup tunnels can be flexibly selected by, e.g., network operators, according to known preferences or policies.

When the construction of the graph is completed, each link in the graph is assigned link weights.

Then, in step 430, the minimum cost for the data transmission along the links can be determined.

One weight is the cost on the link, when the cost is selected for the purpose of protection. The other weight is the failure-probability-wise link weight.

Two different assignment strategies are applied to the two types of links in the graph.

Specifically, for the MPLS links on the primary path, the cost value is set to zero because selection of these links does not increase the protection cost.

The failure-probability-wise link weight of these links is assigned exactly as the risk-weighted failure probability, i.e., pᵢⱼ for MPLS link (i,j).

For the virtual links representing the backup tunnels, the costs are accumulated along the backup tunnel, and their failure-probability-wise link weight is assigned as the risk-weighted joint failure probability of the backup tunnel together with the corresponding primary segment it protects. The calculation of the risk-weighted joint failure probability is described below.

The failure probability of the primary segment in the protection domain from node i to node k, in short as PD[i→k], under risk r ∈ k is

$${p}_{i \to k}^{r} = {\prod }_{j = 1}^{j = k - 1} \text{?} . \\ \text{?} \text{indicates text missing or illegible when filed}$$

Correspondingly, the failure probabilities of the backup tunnels under risk r are also evaluated in the same way as above and denoted by b^{r}_{i→k}. The joint failure probability of the primary segment and its backup tunnel in PD[i→k] under risk

r ∈ R is

q^{r}_{i→k}=p^{r}ᵢ₌ₖb^{r}_{i→}.

The risk-weighted joint failure probability of PD[i→k] is

$${Q}_{i \to k} = {\sum }_{r ∈ R} {π}_{r} {q}_{i \to k}^{r} .$$

Q_{i→k}, which is then assigned as the failure-probability-wise link weight to the virtual backup tunnel i→k.

After this link weight assignment as shown in FIG. 3, an optimal combination of segment protections that provides the minimum joint failure probability (OCSP-MFP) can be determined by using a shortest-path process, as known in the art, on the graph from the origin to the destination using the link weights.

The optimal combination of segment protections, which satisfies the required reliability with minimum cost (OCSP-RGLC) can be obtained by applying the RGLC method mentioned above on the graph.

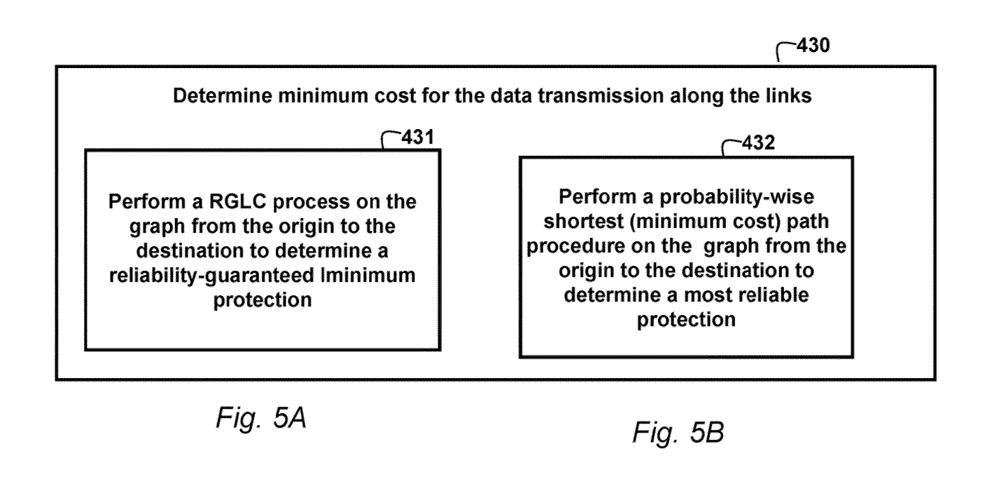

FIGS. 5A-5B show the two alternative 431-432. The first performs the RGLC process on the graph from the origin to the destination to determine a reliability-guaranteed least-cost protection. The second performs the probability-wise shortest path procedure on the graph from the origin to the destination to determine a most reliable protection. Both alternatives are described above.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for protecting data transmission from failures, wherein the data transmissions are from a source to a destination in a Multi-Protocol Label Switching (MPLS) network, and the data transmissions are via a labeled-switch path (LSP) with segment protection in protection domains, comprising the steps of:
constraining a maximum recovery time for each protection domain;
determining, for each protection domain, one or more backup tunnels;
constructing a graph of nodes of the LSP and the backup tunnels, wherein edges in the graph represent the links between the nodes;
assigning a weight to each edge to produce a weighted graph; and
determining, based on the weighted graph, a path from the source to the destination that satisfies a reliability constraint with a minimum cost, by using an optimal combination of segment protections (OCSP) and reliability-guaranteed least-cost (RGLC) according to
$$min {\sum }_{( i , j ) ∈ P} {c}_{ij} , subject to F ( P ) \leq {p}_{req} ,$$
where (i, j) represents the edges of the path, c the costs associated with the edges (i, j), F(P) is a risk-weighted joint failure probability of the LSP with selected backup tunnels, and p_{req} is a required maximum failure probability of the LSP, wherein the steps are performed in a processor.

2. The method of claim 1, wherein the MPLS networks provides differentiated service reliabilities for different users of the network.

3. The method of claim 1, wherein the MPLS network is an optical network.

4. The method of claim 1, wherein the minimum cost is for a specific user of the network.

5. The method of claim 1, wherein a conditional probability of a specific failure is fₛₜ^{r} ∈ [0,1], where r is a risk event, and represent a particular link, and the probability of the failure is
$${p}_{ij}^{r} = 1 - {\prod }_{( s , t ) ∈ {S}_{f}} ( 1 - {f}_{st}^{r} ) .$$

6. The method of claim 1, wherein the maximum recovery time is a restriction on a maximum size of the protection domains.

7. The method of claim 1, further comprising:
constraining a hop count of each protection domain by the maximum recovery time requirement.

8. The method of claim 1, wherein the weight includes a cost on the link selected for the protection, and a failure-probability-wise link weight.

9. The method of claim 1, wherein the RGLC is performed on the graph from the origin to the destination to determine the reliability-guaranteed least-cost protection.

10. The method of claim 1, further comprising:
performing a probability-wise shortest path procedure on the graph from the origin to the destination to determine a most reliable protection.

11. The method of claim 1, wherein an optimal combination of segment protections that provides a minimum joint failure probability is determined by using a shortest-path process.

12. The method of claim 1, further comprising:
constraining the a distance of each protection domain by the maximum recovery time requirement.
